(19) United States
(12) Patent Application Publication
(10) Pub. No.: US 2010/0017715 A1
(43) Pub. Date: Jan. 21, 2010

(54) UNIVERSAL MEDIA BAR FOR CONTROLLING DIFFERENT TYPES OF MEDIA

(75) Inventor: Edward Balassanian, Seattle, WA (US)

Correspondence Address: Implicit Networks, Inc.;Intellectual Property Department, 218 Main Street, Suite 498, Kirkland, WA, 98003, US

(73) Assignee: Implicit Networks, Inc., Kirkland, WA (US)

(21) Appl. No.: 12/504,579

(22) Filed: Jul. 16, 2009

Related U.S. Application Data
(63) Continuation of application No. 11/682,701, filed on Mar. 6, 2007.
Application No. 11/682,701 is a continuation of application No. 10/039,243, filed on Jan. 4, 2002, now abandoned.
(60) Provisional application No. 60/259,828, filed on Jan. 4, 2001.

(51) Int. Cl. G06F 3/01

(52) U.S. Cl. 715/716

(57) ABSTRACT

Techniques for using a universal media bar for controlling different types of media are described.

### PRIORITY CLAIM

This application is a continuation of U.S. application Ser. No. 11/682,701 filed Mar. 6, 2007, which is a continuation of U.S. application Ser. No. 10/039,243 filed on Jan. 4, 2002 which claims the benefit of U.S. Provisional Application No. 60/1259,828, filed Jan. 4, 2001. All related applications incorporated by reference in their entirety as if fully disclosed herein.

### BACKGROUND

The described technology relates generally to controlling the rendering of media.

Many different user interfaces have been developed to allow users to interface with devices that render media. For example, VCRs have user interfaces that typically include a fast forward, rewind, play, and pause buttons. Televisions, in contrast, have user interfaces that include up and down channel buttons and a numeric pad for entry of a specific channel. Device manufactures may try to develop user interfaces that differentiate their devices from and will be more user-friendly than those of other manufacturers. While each user interface may be optimized for a particular device, it is difficult for users to use many different user interfaces. For example, a remote control may have separate and very different user interfaces for controlling a television, a VCR, and a DVD player. As the number of devices and media sources increases, the difficulty of using multiple user interfaces also increases. For example, a television may receive media from a cable, a computer, a VCR, a DVD player, a web server, and so on. Different user interfaces and multiple user interfaces may be provided for controlling media from different media sources that is rendered on the television.

Because computer systems have been developed to allow users to easily route media (e.g., a movie) from a media source (e.g., a DVD player) to a device (e.g., a television) for rendering. The difficulties of using different and multiple user interfaces are becoming more common. One system for routing media is the Strings system developed by BeComm Corporation. Aspects of the Strings system are described in U.S. patent application Ser. No. 09/304,973, entitled “METHOD AND SYSTEM FOR GENERATING A MAPPING BETWEEN TYPES OF DATA” and U.S. patent application Ser. No. 09/474,664, entitled “METHOD AND SYSTEM FOR DATA DEMULT1PLEXING,” which are hereby incorporated by reference. The Strings system dynamically identifies routines (referred to as “beads” or “protocols”) for converting and routing media from a media source to a rendering device. For example, a user may specify that a computer-generated movie is to be rendered on a particular television screen. The Strings system automatically identifies the routines needed to convert the movie from the format of the media source to the format of the rendering device. The routines may include compression routines, formatting routines, and so forth. The routines are linked together to form a “string” of routines for processing the media.

It would be desirable to have consistent graphical user interface for controlling the rendering of different types of media from different media sources to different types of devices. It would also be desirable that the graphical user interface be visually similar to the physical user interface of devices.

### BRIEF DESCRIPTION OF THE DRAWINGS

FIG. 1 is a diagram illustrating a media bar for controlling a movie being played on a television in one embodiment.

FIG. 2A is a diagram illustrating different icons on the primary controls of the media bar in one embodiment.

FIG. 2B is a diagram of a physical device with a media bar in one embodiment.

FIG. 3 is a block diagram illustrating components of the Strings system that uses the media controller in one embodiment.

FIG. 4 is a diagram illustrating the activating or adding of an activity in one embodiment.

FIG. 5 is a diagram illustrating categories of the media for a media source in one embodiment.

FIG. 6 is a diagram illustrating the media that is available for a selected category in one embodiment.

FIG. 7 is a diagram illustrating the user interface when multiple activities have been activated in one embodiment.

FIG. 8 is a diagram illustrating a tablet that is displaying email in one embodiment.

FIG. 9 is a diagram illustrating multiple activities that specify the same appliance in one embodiment.

FIG. 10 illustrates the available setup menu items in one embodiment.

FIG. 11 illustrates a display page for creating a new activity in one embodiment.

FIG. 12 illustrates a display page for creating a virtual appliance in one embodiment.

FIG. 13 illustrates a display page for setting attributes of an appliance in one embodiment.

FIG. 14 illustrates a display page for selection of various media options in one embodiment.

FIG. 15 is a flow diagram illustrating the processing of displaying a media bar in one embodiment.

FIG. 16 is a flow diagram illustrating the process of activating an activity in one embodiment.

FIG. 17 is a flow diagram illustrating the processing of creating an activity in one embodiment.

### DETAILED DESCRIPTION

A method and system for providing a consistent user interface • for controlling the rendering of different types of media by different types of appliances (e.g., devices) is provided. A media controller provides a media bar with a consistent user interface across media types and appliance types. In one embodiment, the media bar has buttons that have the same shape and position regardless of the media type, media source, and appliance type. The media controller may customize icons displayed on the buttons to reflect the media type, media source, or appliance type being controlled. For example, a media bar may have a main control button with a skip ahead button and a fast forward button to its right and a skip back button and a rewind button to its left. The functions of the buttons may change based on the media type, media source, and appliance type that is being controlled. For example, the function of the skip ahead button may be to advance to the next channel when a movie (e.g., media type) from a cable (e.g., media source) is being rendered on a television (e.g., appliance), and the function of the skip ahead button may be to advance to the next track when audio from a CD player is being rendered on the television.

An appliance is a collection of components that are combined to render media from a single media source. An appliance can be either real or virtual. A real appliance is generally a collection of components that are physically connected and designed to work together. For example, a television is a real appliance that includes two components: a screen and speakers. A virtual appliance is a collection of components from different physical devices that might not be physically connected or related. For example, the screen of a television and the speakers of the stereo system can be combined to form a virtual appliance.

In one embodiment, the media controller allows users to define and select various “activities” that can be performed. An activity is a combination of a media source and an appliance in which the media generated by the media source is rendered on the appliance. For example, a user may define an activity with a media source of cable and an appliance of television. The media controller may allow the user to specify user-friendly names for the activities, such as “TV is watching cable.” The media controller allows the user to activate and deactivate various activities. When an activity is activated, the media controller directs the rendering of media from the media source to the appliance defined by the activated activity. In one embodiment, the media controller activates an activity by directing the Strings system to route media from the media source to the appliance. For example, a user may activate an activity that renders media (e.g., TV channel) from a cable on a television and another activity that renders media from the same cable on a stereo system. Each activity can be controlled using the media bar that has the same overall appearance.

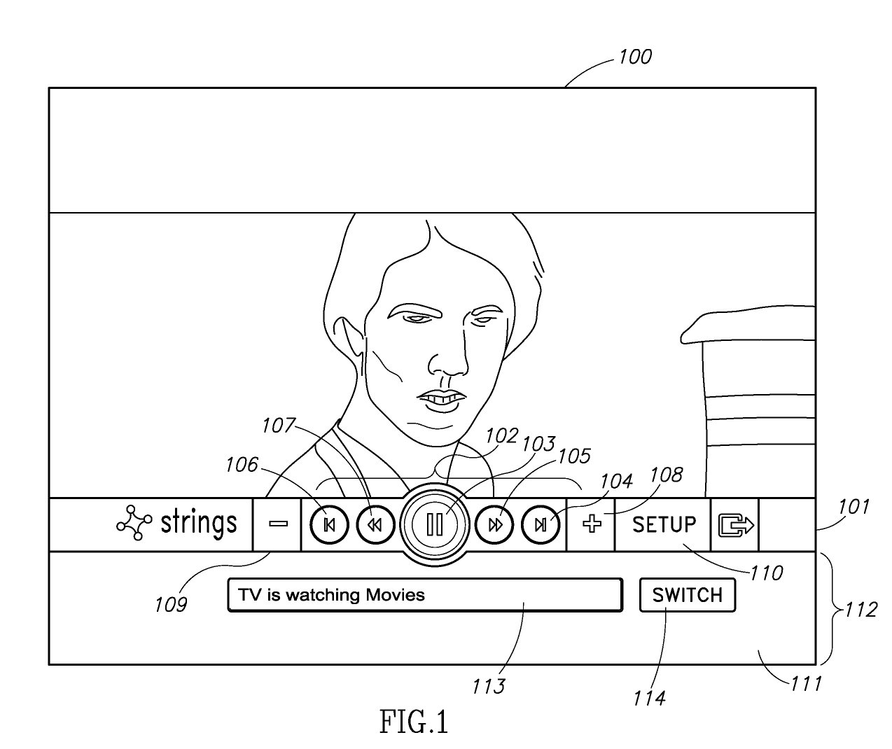

FIG. 1 is a diagram illustrating a media bar for controlling a movie from a movie store being played on a television—in one embodiment The television screen 100 displays the movie, the media bar 101, and an activities list 112. The media bar includes primary buttons 102 that include main control button 103, a skip ahead button 104, a fast forward button 105, a skip back button 106, and a rewind button 107. The icons of these primary buttons may be changed to represent the function performed by the system when a button is selected. For example, the main control button is currently displaying a pause icon (e.g., two vertical bars) indicating that when the main control button is selected, the movie will be paused. If the movie is currently paused, the main control button may contain a play icon (e.g., a right arrow) to indicate that when the main control button is selected the movie will start playing. The media bar also includes activate activity button 108, deactivate activity button 109, setup button 110, and toggle view button 111. When the setup button is selected, the media controller allows the user to define and modify activities, define and modify appliances, and control certain media. The activate and deactivate activity buttons allow the user to activate and deactivate activities that have been defined. The toggle view button allows the user to toggle between screens showing picture-in-picture video for activities that do not have the highest priority. The activities list includes a button for each activity that is currently active. For example, the activity button 113 corresponds to the activity named “TV is watching movies.” The switch button 114 allows the user to select which activity is to be controlled by the media bar. When an activity button is selected, the button may be replaced by activity-specific controls as described below.

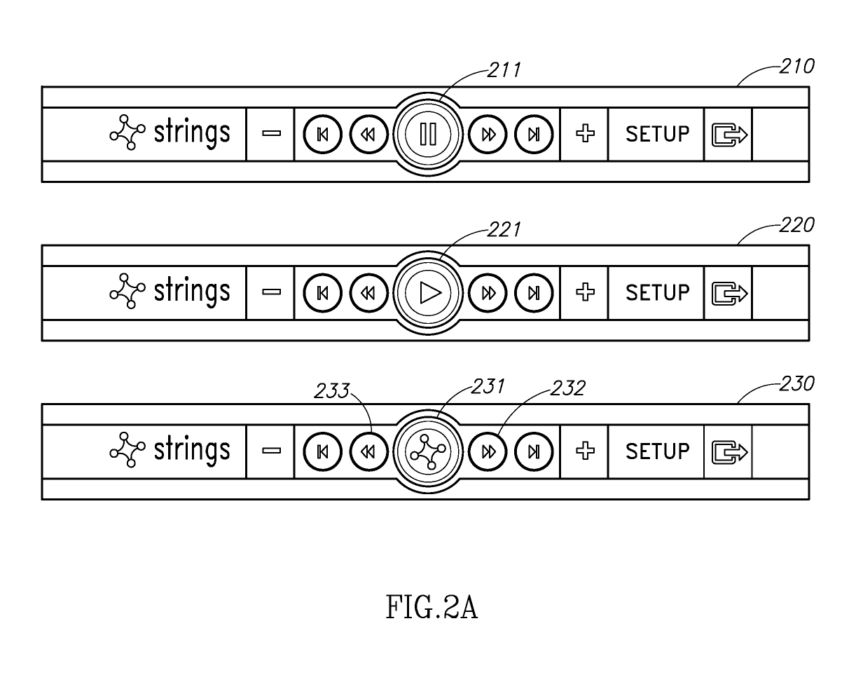

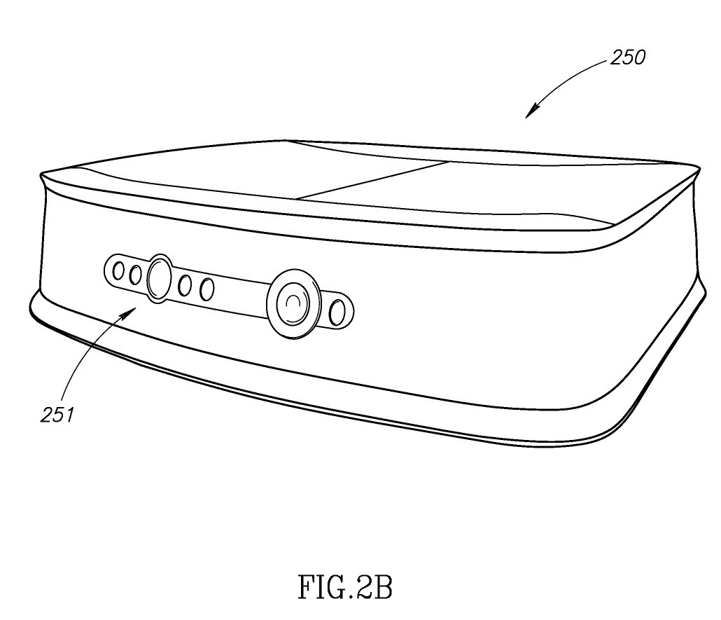

FIG. 2A is a diagram illustrating different icons on the primary controls of the media bar in one embodiment. The media bar 210 represents buttons that are displayed when a movie is being played. In this case, the main control button 211 indicates a pause function. The media bar 220 also represents buttons that are displayed when a movie is paused In this case, the main control button 221 indicates a play function. The media bar 230 represents buttons that are displayed when web pages are being viewed. In this case, the main control button 231 may correspond to the enter key of the keyboard and may contain a special icon. The fast forward button 232 and the rewind button 233 may represent the function of scrolling through a web page that does not fit on a display. The icons on these buttons suggest their scrolling function.

FIG. 2B is a diagram of a physical device with a media bar in one embodiment. The device 250 includes the media bar 251. The media bar contains physical primary control buttons that are similar in appearance to the GUI primary control buttons of FIG. 1. Because the physical and GUI primary control buttons have a consistent appearance, users will find the controlling of various activities to be intuitive and consistent.

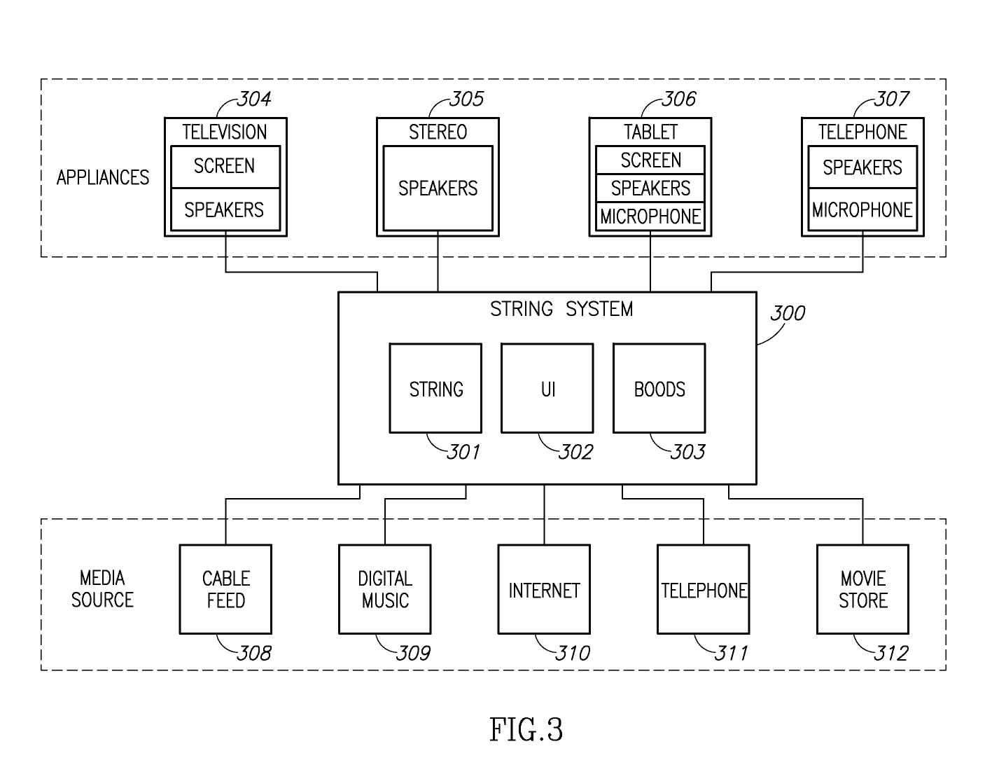

FIG. 3 is a block diagram illustrating components of a Strings system that uses the media controller in one embodiment. The Strings system 300 includes a Strings component 301, a graphical user interface (“GUI”) component 302, and a beads store 303. A bead is a routine that inputs media of one type and outputs media of another type. The Strings component identifies the sequence of beads that can be used to convert and route media from a media source to an appliance. The GUI component implements the media controller that provides a consistent user interface for controlling the appliances. In this example, the appliances include a television 304 with screen and speaker components, a stereo 305 with a speaker component, a tablet 306 with screen, speaker, and microphone components, and a telephone 307 with speaker and microphone components. In this case, the microphone components may be considered to be media sources. The media sources include a cable feed 308, a digital music feed 309, an Internet connection 310, and a movie store 311. The movie store may be a collection of movies stored locally on a disk or other mass storage device. Although shown within a single block in this figure, the Strings system may be distributed across many different computing devices of a network. In particular, each of the appliances and media sources may have components of the Strings system. The computers (e.g., within appliances or upon which the Strings system executes) may include a central processing unit, memory, input devices (e.g., keyboard and pointing devices), output devices (e.g., display devices), and storage devices (e.g., disk drives). The memory and storage devices are computer-readable media that may contain instructions that implement the Strings system. In addition, the data structures and message structures may be stored or transmitted via a data transmission medium, such as a signal on a communications link. Various communications may be used, such as a local area network, a wide area network, or a point-to-point dial-up connection.

Strings includes a Namespace component that allows attributes for objects, such as appliances, media sources, media types, media, and so on, to be registered. In one embodiment, each appliance and each media sources has its attributes registered with the Namespace component. The Namespace component provides a query mechanism by which registered data can be retrieved based on the attribute values. For example, a query may request to retrieve all data for objects with a value for its “type” attribute of “appliance.” The data for such an appliance can include a definition of the controls (e.g., fast forward) that are available to control the appliance. The media controller uses the Namespace component to retrieve appliance and media data and to store data defining activities.

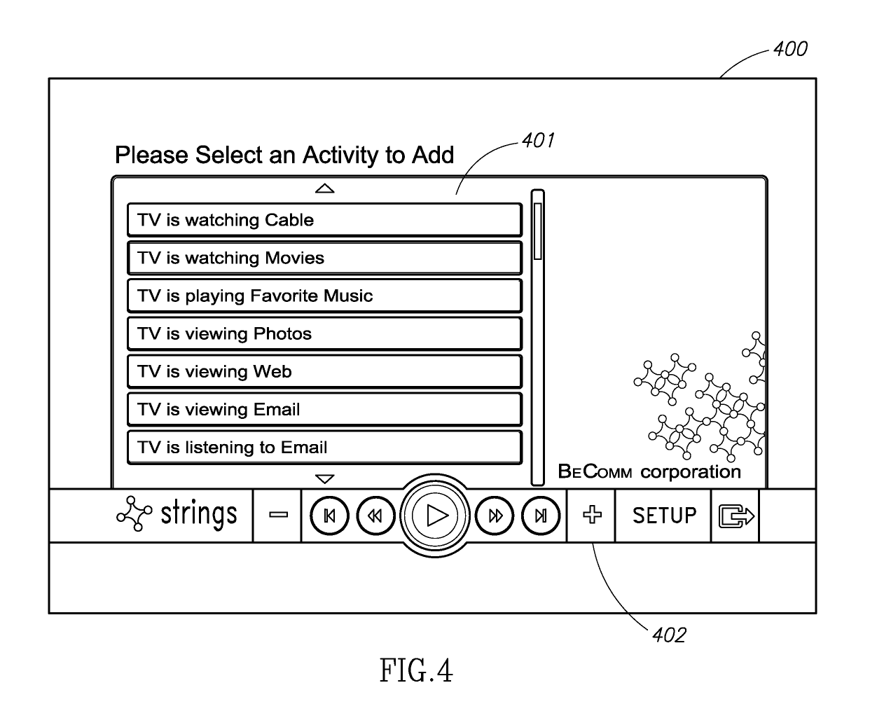

FIG. 4 is a diagram illustrating the activating or adding of an activity in one embodiment. The user selects the activate activity button 402. In response, the media controller displays a list of the defined activities 401 on display 400 (e.g., retrieved from the Namespace component). The defined activities include “TV is watching cable,” “TV is watching movies,” and so on. The list also includes a scroll bar for scrolling through the list of defined activities. A user activates an activity by selecting the activity from the list. As described above, an activity specifies a media source and an appliance certain media sources, such as a cable, may have multiple media (e.g., channels) associated with them. If so, the media controller requests the user to specify the media to be initially associated with the activity. After the activity is activated, the media controller allows the user to select a different media (e.g., change channels) for that activity. In one embodiment, an activity can be defined as having a media source or a specific media.

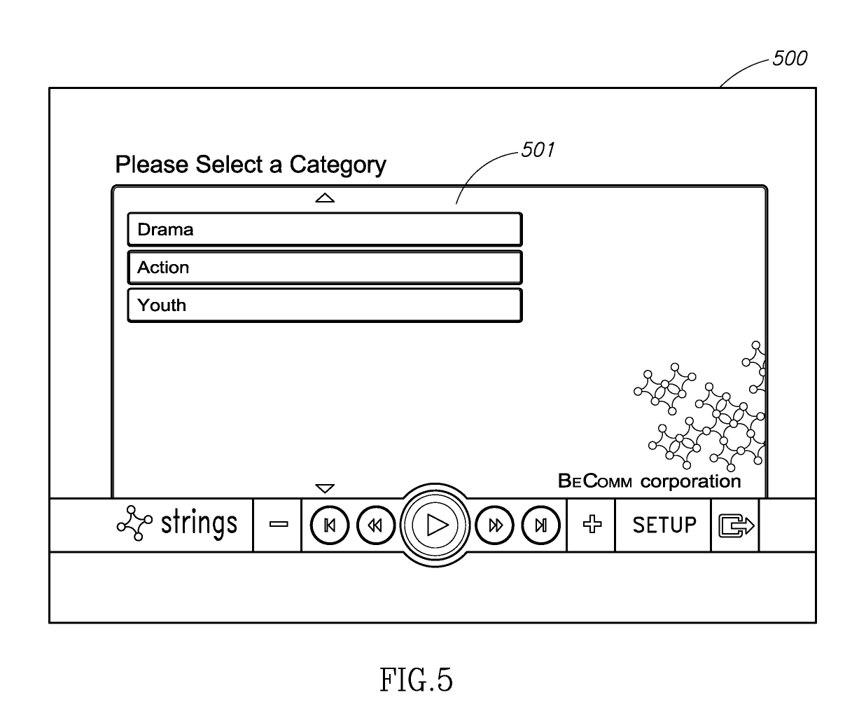

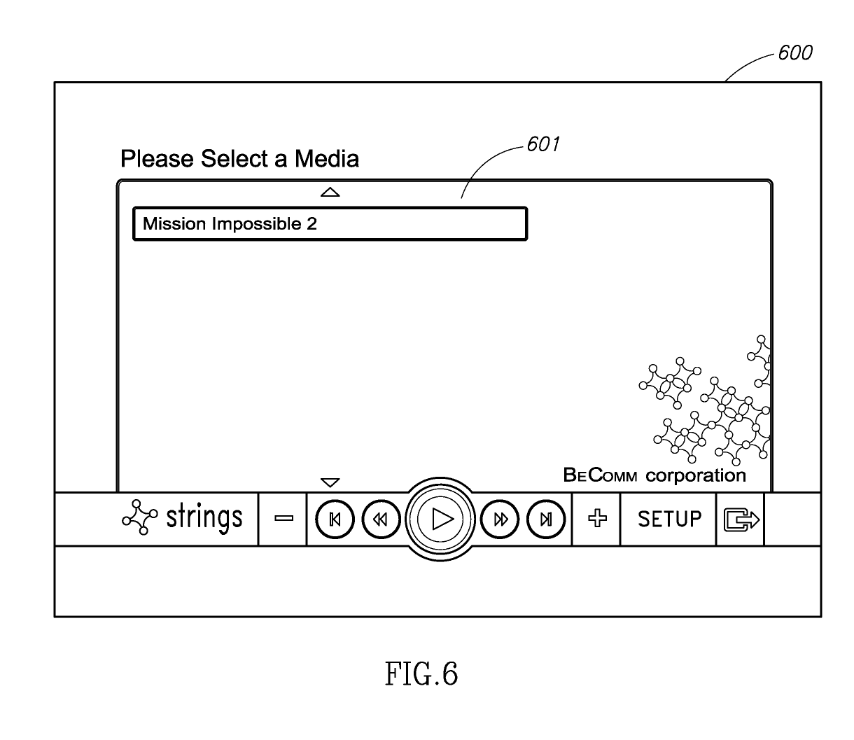

FIG. 5 is a diagram illustrating categories of the media for a media source in one embodiment. In this example, a user selected to activate an activity with a movie as the media source. The media of the movie are divided into drama, action, and youth categories as displayed by the category list 501. The media controller may identify these categories by querying the Namespace component. In general, each appliance and media source may have its attributes stored by the Namespace component. FIG. 6 is a diagram illustrating the media that is available for a selected category in one embodiment. In this example, a user activates the activity by selecting the media named “Mission Impossible 2.” FIG. 1 illustrates the display generated when this media is selected.

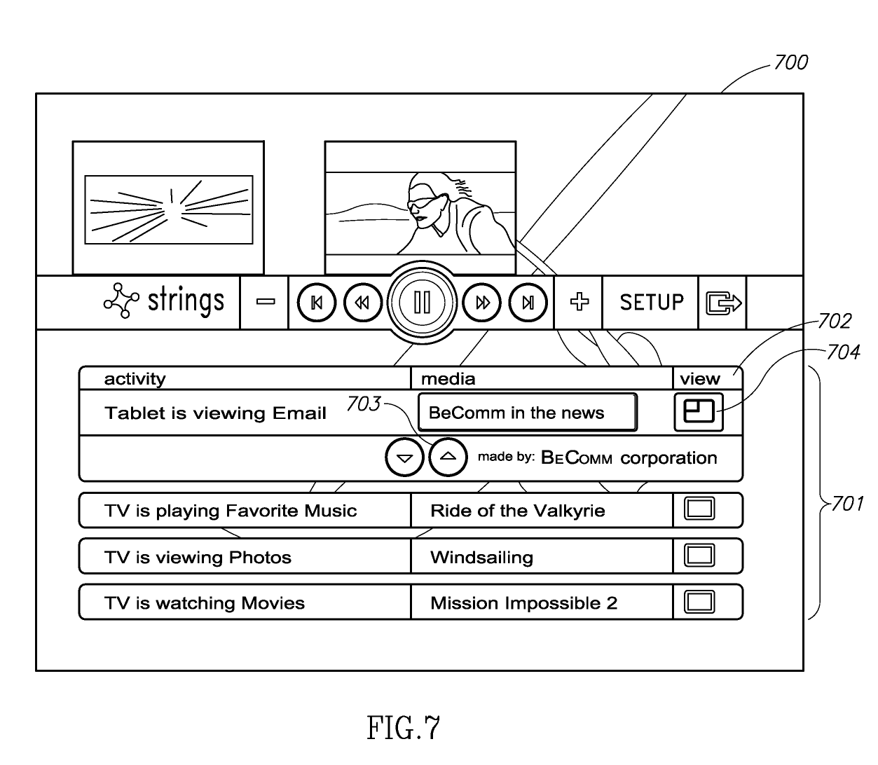

FIG. 7 is a diagram illustrating the user interface when multiple activities have been activated in one embodiment. In this example, the activities of “Tablet is viewing email,” “TV is playing favorite music,” “TV is viewing photos,” and “TV is watching movies” have been activated as indicated by the activities list 701. The activities list indicates the actual media that is currently being rendered by the activity. In this example, the movie “Mission Impossible 2” is being rendered by the activity “TV is watching movies.” The activity button for “Tablet is viewing email” has been selected by the user. In response, the media controller displays an expanded activity button 702 for that activity. That expanded activity button includes activity and media specific controls that may not be provided by the media bar. The activity and media specific controls may be stored by the Namespace component. In this example, the buttons 703 may be used to select the next and previous email. The view button 704 may be used to toggle the rendering of the media between a full-screen and picture-in-picture type display. In this example, the activity of “Tablet is viewing email” does not result the rendering of email on the television but rather on a tablet. Nevertheless, the activity directed to the tablet can be controlled through the television-based user interface. A similar user interface is displayed on the tablet.

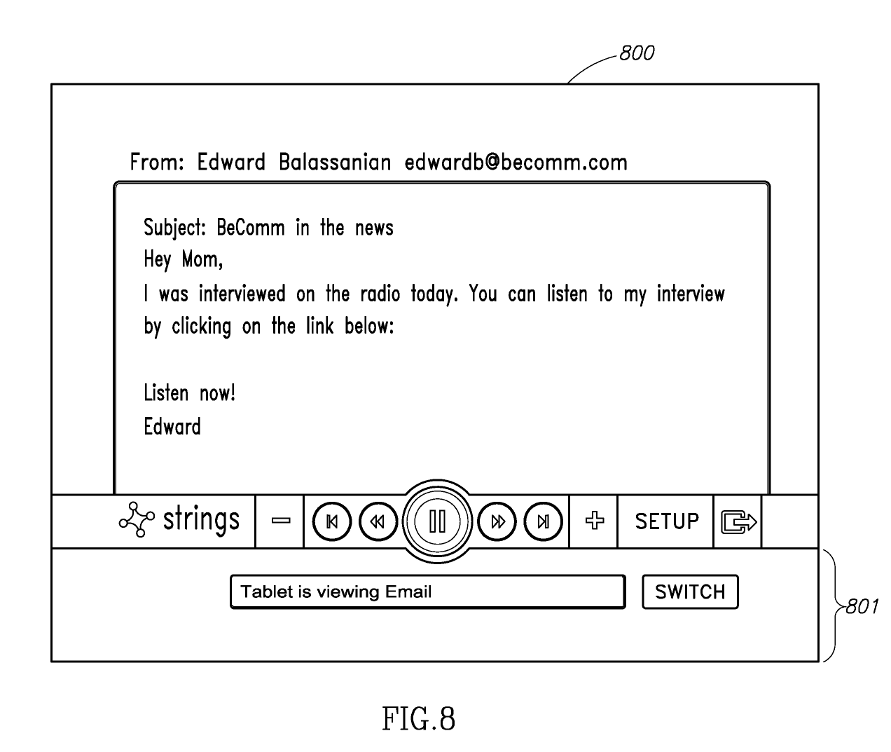

FIG. 8 is a diagram illustrating a tablet that is displaying email in one embodiment. The tablet screen 800 includes a media bar that is similar in appearance to the media bar displayed on the television for controlling movies. The fast forward and rewind buttons of the media bar are used to scroll the email up and down as suggested by their icons, and the skip ahead and skip back buttons are used to go to the next or previous emails or to the end or beginning of the current email. The activities list area 801 includes a button for each activated activity.

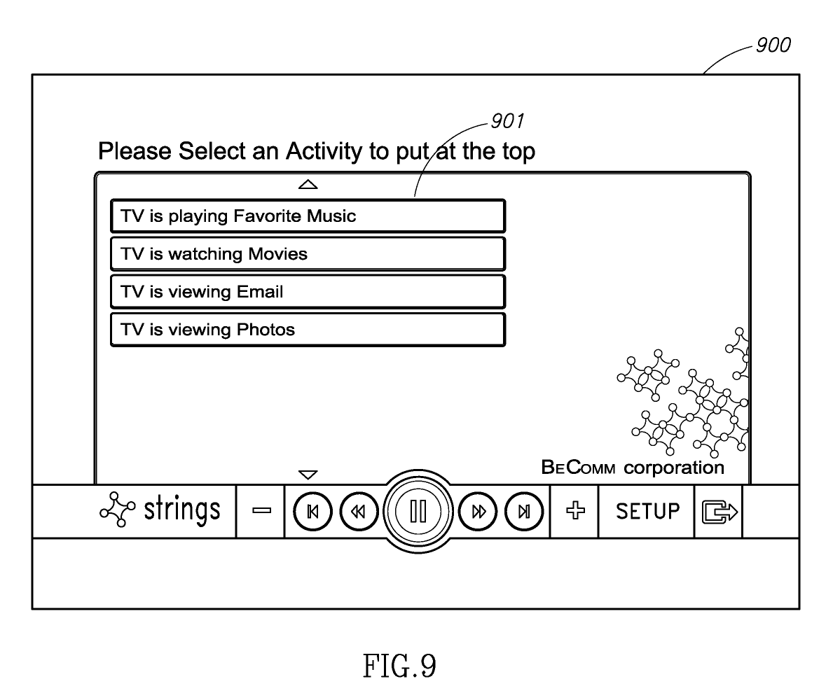

FIG. 9 is a diagram illustrating multiple activities that specify the same appliance in one embodiment. In this example, the activities of “TV is playing favorite music,” “TV is watching movies,” and “TV is viewing photos” all specify the television. The rendering of the photos on the TV conflicts with the rendering of the video of the movie, and the rendering of the music on the TV conflicts with the rendering of the audio of the movie. The media controller allows a user to specify which activity has the highest priority. In this example, “TV is playing favorite music” has the highest priority. Therefore, the music, rather than the audio of the movie, is rendered by the television speaker. Since movies have a higher priority than the photos, the video of the movie, rather than the photos, is rendered by the television screen.

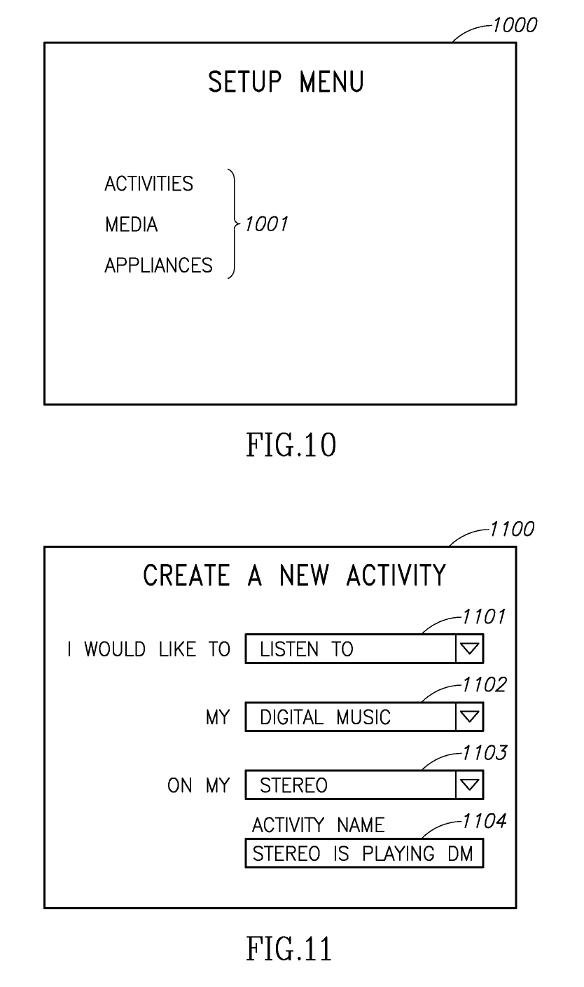

FIGS. 10-14 are diagrams illustrating display pages of the setup functions of the media controller in one embodiment. The navigation buttons that allow the user to navigate from one display page to the next have been omitted. FIG. 10 illustrates the available setup menu items in one embodiment. Display page 100 lists the menu items 1001 of activities, media, and appliances. The activities menu item is selected to define and modify the activities of the system. The media menu item is selected to specify various media options such as defining playlists and specifying TV favorites. The appliances menu item is selected to specify the attributes of appliances and to define virtual appliances.

FIG. 11 illustrates a display page for creating a new activity in one embodiment. Display page 1100 includes an action drop-down list 1101, a media source to drop-down list 1102, and an appliance drop-down list 1103. The user selects an action (e.g., listen to), a media source (e.g., digital music), and an appliance (e.g., stereo) to define an activity. The display page also includes activity name field 1104 that allows a user to specify a user-friendly name for the activity. The Namespace component of the Strings system stores data defining the media sources and appliances.

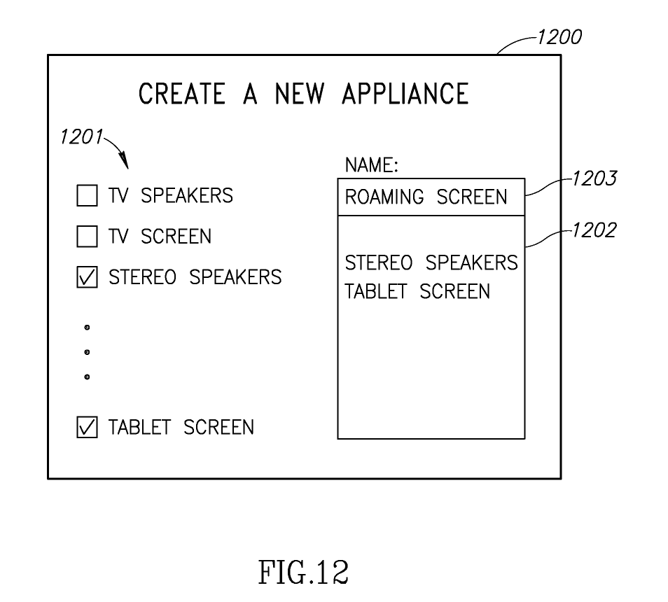

FIG. 12 illustrates a display page for creating a virtual appliance in one embodiment. Display page 1200 includes the list of components 1201 (that may also include the real and virtual appliances) along with check boxes for selecting various components. This display page also includes a name field in which the user can specify the name of a virtual appliance. In this example, the user has defined a virtual appliance that includes stereo speakers and a tablet screen. The user has named the virtual appliance “roaming screen.” When a virtual appliance is created, it is displayed in the components list 1201.

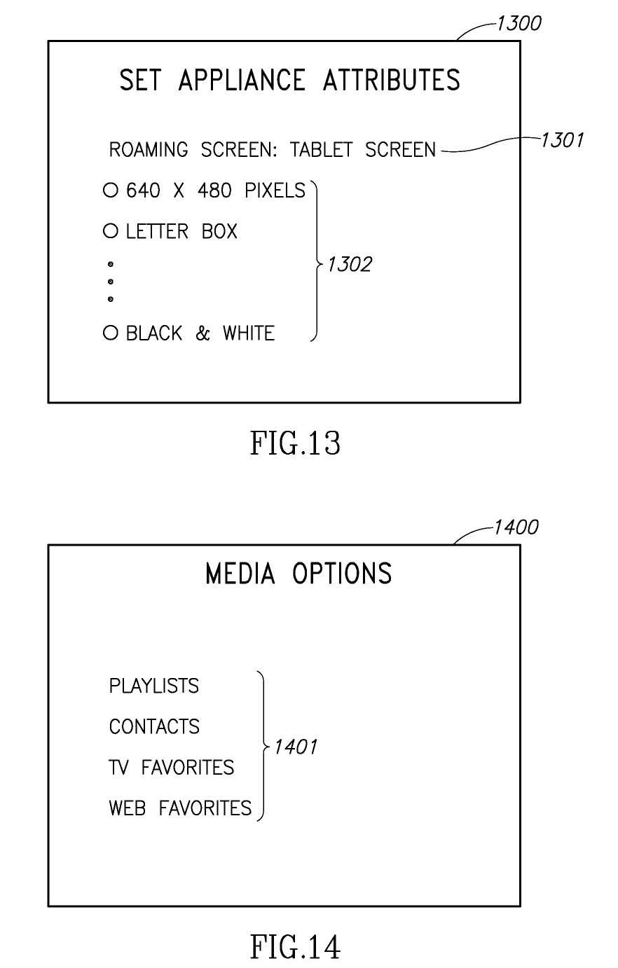

FIG. 13 illustrates a display page for setting attributes of an appliance in one embodiment. Display page 1300 lists various attributes 1302 associated with the tablet screen of the “roaming screen” virtual appliance 1301. The attributes may have radio buttons associated with them for selecting the attribute. The media controller may set and get the attributes from an object representing the tablet screen. The definition and attributes of a virtual appliance may be stored using the Namespace component.

FIG. 14 illustrates a display page for selection of various media options in one embodiment. In this embodiment, display page 1400 lists the media options of playlist, contacts, TV favorites, and web favorites. The playlist option allows the user to define a playlist of media, such as a list of songs that comprise a media. The contacts option may allow the user to define contact information, such as names and email addresses. The TV and web favorites options may allow the user to define various favorite television shows and web sites.

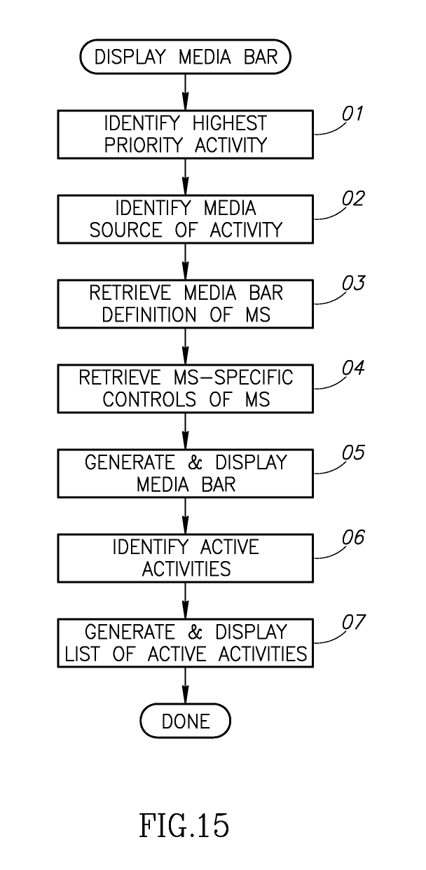

FIGS. 15-17 are flow diagrams illustrating processing of the media controller in one embodiment. FIG. 15 is a flow diagram illustrating the process of displaying a media bar in one embodiment. In block 1501, the controller identifies the activity to be controlled. The controller may use the Namespace component to store the activity definitions. In block 1502, the controller identifies a media source of the activity. In block 1503, the controller retrieves the media bar definition for that media source or combination of media source and appliance. The media bar definition may be stored by the Namespace component. In block 1504, the controller retrieves the media source specific controls from the media source. For example, a television may have a numeric pad control that can be used to input a specific channel. Such a media source specific control may be displayed when an activity button in the activities list is selected. In block 1505, the controller generates and displays the media bar using the icons specified by the definition of the media bar and the current state (e.g., paused) of the activity. In block 1506, the controller identifies the list of activated activities, which may be stored by the Namespace component. In block 1507, the controller generates and displays a list of the activated activities.

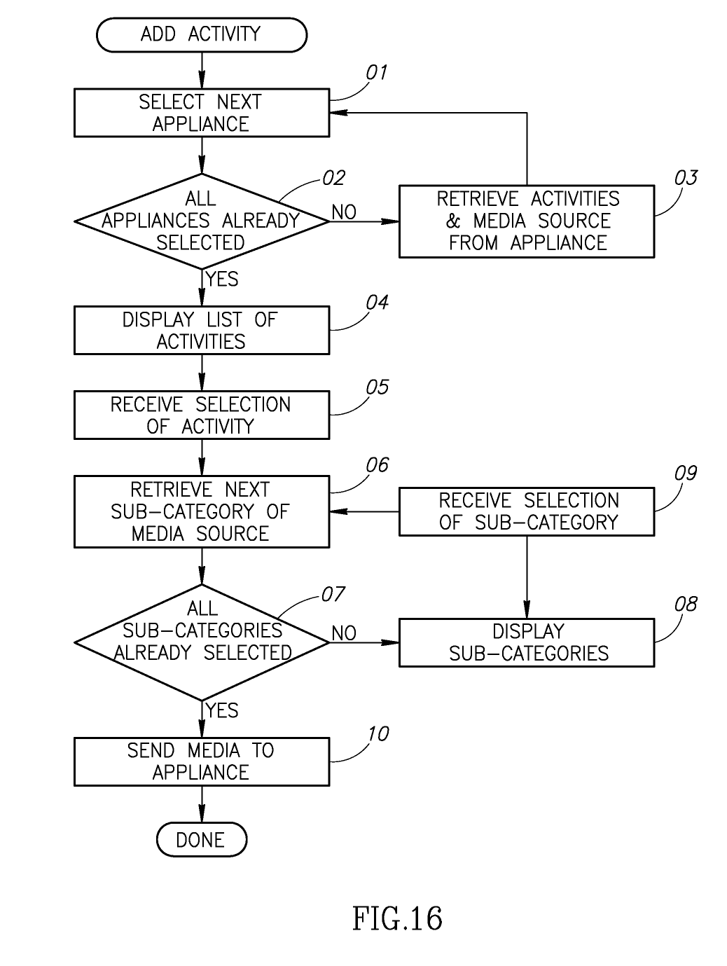

FIG. 16 is a flow diagram illustrating the process of activating an activity in one embodiment. In block 1601-1603, the controller queries the Namespace component for the activities that are defined for each appliance. In block 1601, the controller selects the next appliance starting with the first. In decision block 1602, if all the appliances have already been selected, then the controller continues at block 1604, else the controller continues at block 1603. In block 1603, the controller retrieves the activities associated with the selected appliance and then loops to block 1601. Alternatively, the activity definitions can be stored independently from the appliance data stored by the Namespace component. In block 1604, the controller displays the list of the defined activities. In block 1605, the controller receives a selection of an activity to activate. In blocks 1606-1609, the controller loops allowing the user to select various categories of media and ultimately a specific media to be initially associated with the activity. In block 1606, the controller retrieves the next sub-categories of the media for that media source, as indicated by the data stored—by the Namespace component. In decision block 1607, if a specific media has already been selected, then the controller continues at block 1610, else the controller continues at block 1608. In block 1608, the controller displays the sub-categories of media or the media themselves. In block 1609, the controller receives a selection of a sub-category or media and continues at block 1606. In block 1610, the controller notifies the Strings system to send the selected media to the appliance and then completes.

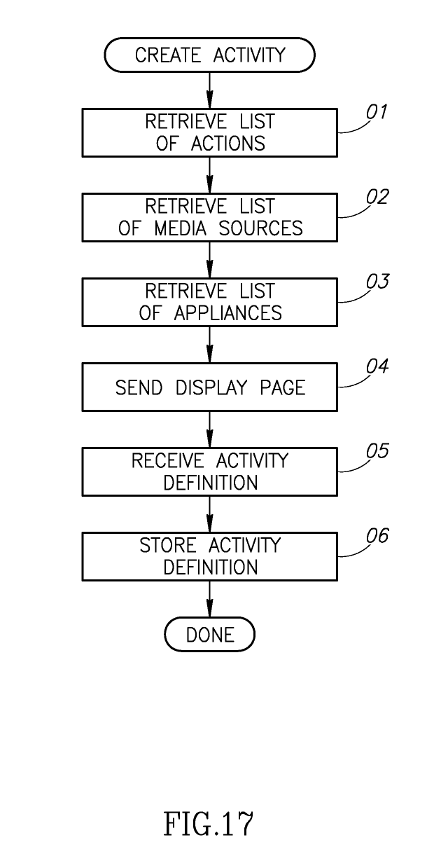

FIG. 17 is a flow diagram illustrating the processing of creating an activity in one embodiment. In block 1701, the controller retrieves a list of the actions that are available. In block 1702, the controller retrieves a list of media sources that are available. In block 1703, the controller retrieves a list of appliances that are available. In block 1704, the controller displays a display page with a drop-down list for the actions, media sources, and appliances. In block 1705, the controller receives the definition of an activity. In block 1706, the controller stores the definition of the activity with the Namespace component and then completes.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I claim:

1. A method in a computing system for displaying a media bar for controlling the playback of media on appliances, comprising:
a plurality of buttons providing control of media;
identifying media for rendering on appliance, the media having a known type;
identifying appliances available to render identified media from a plurality of appliances;
selecting one or more available appliances for media playback;
modifying the presented buttons functionality based on identified media type; and
displaying media bar for controlling identified media playback on the selected appliances.
